(19) United States
(12) Patent Application Publication
(10) Pub. No.: US 2015/0076307 A1
(43) Pub. Date: Mar. 19, 2015

(54) Holder Assembly

(71) Applicant: Top Victory Investments Ltd., Kowloon (HK)

(72) Inventors: Tsung-Ping Tsai, New Taipei City (TW); Tzu-Ming Huang, New Taipei City (TW)

(73) Assignee: Top Victory Investments Ltd., Kowloon (HK)

(21) Appl. No.: 14/025,891

(22) Filed: Sep. 13, 2013

(51) Int. Cl. F16M 11/14; F16M 11/22; A47B 97/00

(52) U.S. Cl. CPC F16M 11/14; A47B 97/00; F16M 11/22; A47B 2097/005
USPC 248/397

(57) ABSTRACT

A holder assembly for supporting a displaying device is disclosed in the present invention. The holder assembly includes a base, a brace and a supporting arm. An end of the brace is connected to the base, and a sphere is disposed on the other end of the brace. An end of the supporting arm is connected to the displaying device, and a pivot portion is disposed on the other end of the supporting arm. The pivot portion corresponds to the sphere, and the sphere is rotatably disposed on the pivot portion. Comparing to the prior art, the present invention has preferable convenience.

### BACKGROUND OF THE INVENTION

1. Field of the Invention

The present invention relates to a holder assembly, and more particularly, to a holder assembly for supporting a displaying device.

2. Description of the Prior Art

A conventional displaying device including the liquid crystal display and the plasma display has thin-typed and tablet-typed features. The conventional displaying device is utilized to show image and information at private place or public place, such as the office, the exhibition site and the department store. In the kind of application, a view angle of the displaying device is adjusted frequently for preferred performance. Further, the view angle of the displaying device may be adjusted for showing the image information to associates or family in the office or at home.

Generally, the displaying device is fixed on the wall or the ceiling via the fixing holder, or is fixed on the table, the ground and any other suitable plane via the supporting holder. Procedure of utilizing the fixing holder to adjust the view angle of the displaying device has complicated steps, such as unlocking the fixing component of the fixing holder, adjusting the holder to the predetermined angle, and locking the fixing component. Procedure of utilizing the supporting holder wastes human force, such as lifting the supporting holder with the displaying device, moving to the predetermined position, and lowering the supporting holder. Besides, adjustable angle and operation method of the conventional holder are constrained, the conventional holder can not be applied to the novel displaying device appropriately. The conventional skill does not solve the existing drawbacks.

### SUMMARY OF THE INVENTION

The present invention provides a holder assembly for easily adjusting a view angle of the displaying device, so as to increase convenience of angle adjustment of the displaying device and enhance utility of the displaying device.

According to the claimed invention, a holder assembly for supporting the displaying device is disclosed in the present invention. The holder assembly includes a base, a brace and a supporting arm. An end of the brace is connected to the base, and a sphere is disposed on the other end of the brace. An end of the supporting arm is connected to the displaying device, and a pivot portion is disposed on the other end of the supporting arm. The pivot portion corresponds to the sphere, and the sphere is rotatably disposed on the pivot portion.

According to an embodiment of the present invention, the pivot portion includes two pivot planks. An arc surface is hollowly formed on each pivot plank. The two arc surfaces face to each other and fit in with a surface of sphere, and the sphere is rotatably clamped between the two arc surfaces.

According to the embodiment of the present invention, the supporting arm includes two lateral planks. Ends of the two lateral planks are connected to the displaying device, and the pivot planks are respectively disposed on the other ends of the two lateral planks.

According to the embodiment of the present invention, the two lateral planks are connected to each other, and an opening is formed between the two pivot planks.

According to the embodiment of the present invention, the brace includes a support bar. A width of the opening is substantially equal to a sectional diameter of the support bar. The width of the opening is substantially smaller than a diameter of the sphere. An end of the support bar is connected to the sphere, and the other end of the support bar passes through the opening to connect the brace.

According to the embodiment of the present invention, the support bar rotates relative to the pivot plank between a first end and a second end of the opening.

According to the embodiment of the present invention, rotation between the support bar and the pivot plank is substantially equal to 90 degrees when the support bar rotates relative to the pivot plank from the first end of the opening to the second end of the opening.

According to the embodiment of the present invention, the arc surface includes an abrasion proof layer, and the abrasion proof layer contacts the sphere.

According to the embodiment of the present invention, the pivot plank and the sphere are made of aluminum alloy, zinc alloy, polyacetal or bakelite. The abrasion proof layer is made of polyacetal.

According to the embodiment of the present invention, a connect plank is pivotally disposed on an end of the lateral plank opposite to the pivot plank. The connect plank is connected to a connector conforming to VESA standard of the displaying device.

The holder assembly of the present invention can adjust the view angle of the displaying device conveniently and rapidly. The displaying device not only can execute parallel rotation relative to the holder assembly within 360 degrees, but also can overturn to 90 degrees at the perpendicular direction via the holder assembly. Comparing to the prior art, the present invention can increase rotation convenience of the displaying device and enhance utility of the displaying device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a holder assembly according to a preferred embodiment of the present invention.

FIG. 2 is a diagram of the holder assembly without a brace according to the preferred embodiment of the present invention.

FIG. 3 is a diagram of the holder assembly and a displaying device at a firs operation mode according to the preferred embodiment of the present invention.

FIG. 4 is a diagram of the holder assembly and the displaying device at a second operation mode according to the preferred embodiment of the present invention.

### DETAILED DESCRIPTION

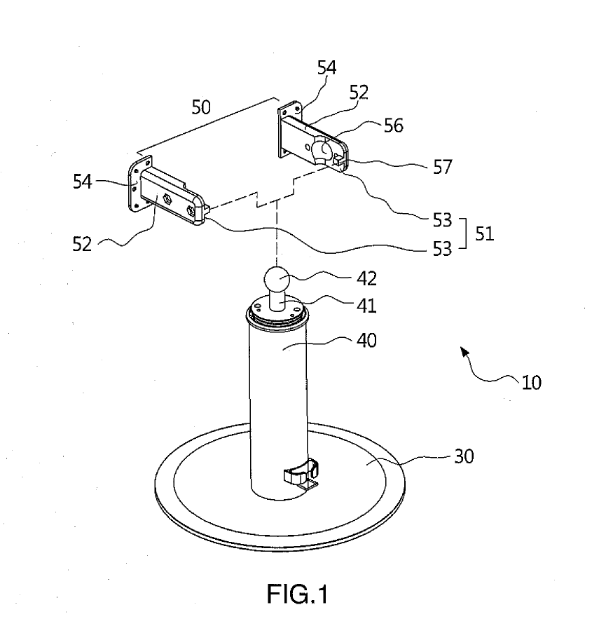

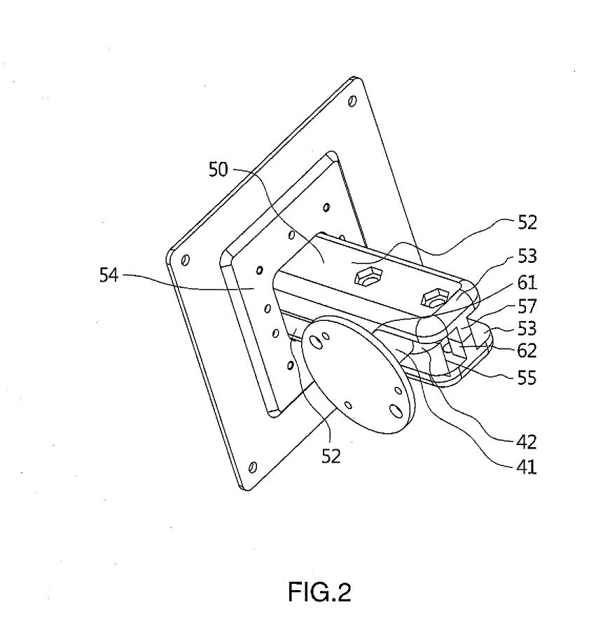

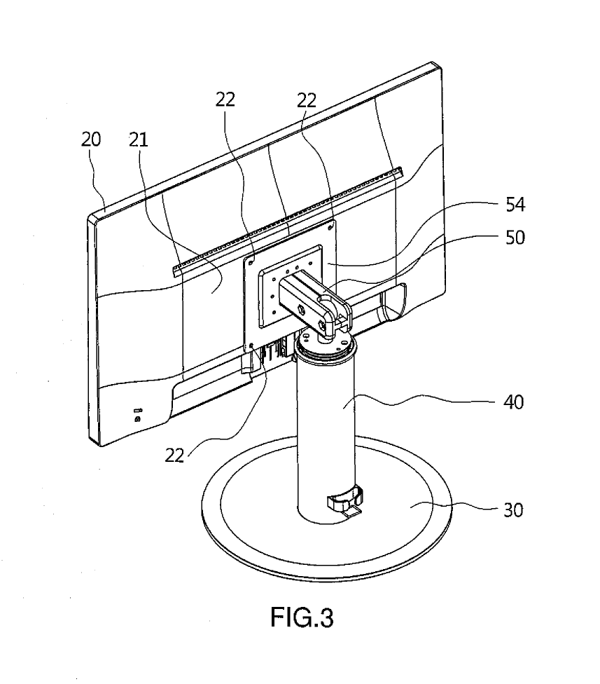

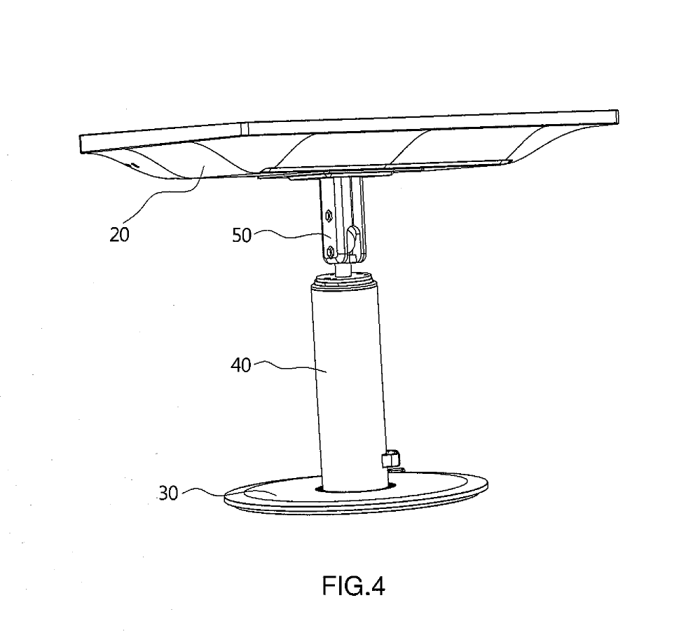

Please refer to FIG. 1 to FIG. 4, which illustrate a holder assembly according to an embodiment of the present invention. The holder assembly 10 is used to support a displaying device 20. In this embodiment, the displaying device 20 can be the LCD with touch function, and a connector 22 conforming to Video Electronics Standards Association (VESA) standard is disposed on a back 21 of the displaying device 20. The displaying device 20 is not limited to the above-mentioned embodiment, and depends on actual demand. The holder assembly 10 includes a base 30, a brace 40 and a supporting arm 50. The base 30 can be a disk structure. The brace 40 can be a cylinder structure. An end of the brace 40 is connected to center of the base 30, and a support bar 41 is disposed on the other end of the brace 40. An end of the support bar 41 is connected to center of a top surface of the brace 40. It is to say, the support bar 41 and the brace 40 are coaxial, and the support bar 41 stretches along an axle of the brace 40. A sectional diameter of the support bar 41 is smaller than a sectional diameter of the brace 40. A sphere 42 is connected to an end of the support bar 41 opposite to the brace 40. A diameter of the sphere 42 is greater than the sectional diameter of the support bar 41. The sphere 42 is made of abrasion proof material, such as aluminum alloy, zinc alloy, polyacetal or bakelite.

An end of the supporting arm 50 is connected to the displaying device 20. A pivot portion 51 is disposed on the other end of the supporting arm 50 opposite to the displaying device 20. The pivot portion 51 corresponds to the sphere 42, and the sphere 42 is rotatably disposed on the pivot portion 51. The supporting arm 50 includes two lateral planks 52 and two pivot planks 53. The pivot plank 53 stretches from an end of the lateral plank 52. In this embodiment, the lateral plank 52 is integrated with the pivot plank 53 monolithically. A connect plank 54 is disposed on an end of the lateral plank 52 opposite to the pivot plank 53. The connect plank 54 is connected to the connector 22, which conforms to VESA standard, disposed on the back 21 of the displaying device 20. In the other embodiments, the connect plank can pivot to the lateral plank via a shaft for an angle adjustment of the displaying device. The two lateral planks 52 can be connected to each other in an engaging manner or a locking manner, and an opening 55 is formed between the two pivot planks 53.

Two arc surfaces 56 are respectively hollowly formed on inner sides of the two pivot planks 53. The two arc surfaces 56 face to each other and fit in with a surface of the sphere 42. When the two lateral planks 52 are connected, the pivot planks 53 respectively press two sides of the sphere 42, and the sphere 42 can be rotatably clamped between the two arc surfaces 56 in a tight fit manner. Friction generated by the tight fit manner can be utilized to fix a relative angle between the displaying device 20 and the holder assembly 10. For abrasion between the pivot plank 53 and the sphere 42, the pivot plank 53 is preferably made of the abrasion proof material, such as aluminum alloy, zinc alloy, polyacetal or bakelite. In the other embodiments, material selection of the sphere and the pivot plank is designed according to a weight of the displaying device for altering the friction between the sphere and the pivot plank. For example, the displaying device has huge volume and heavy weight, the sphere and the pivot plank have to be made of the abrasion proof material with higher coefficient accordingly. In the other embodiments, an abrasion proof layer can be disposed on the arc surface, which contacts against the sphere to generate the friction with the sphere so as to prevent the abrasion. Further, the abrasion proof layer is preferably made of polyacetal, and is adhered to the arc surface. The abrasion proof layer can be replaced according to user's actual demand.

When the two lateral planks 52 are connected, the opening 55 is formed between the two pivot planks 53. A width of the opening 55 is substantially equal to or greater than a sectional diameter of the support bar 41, and the width of the opening 55 is smaller than the diameter of the sphere 42, so that the sphere 42 can be kept between the two arc surfaces 56. Meanwhile, an end of the support bar 41 passes through the opening 55 to connect the brace 40. The support bar 41 can rotate relative to the pivot plank 53 between a first end 61 and a second end 62 of the opening 55. An action that the support bar 41 rotates relative to the pivot plank 53 between the first end 61 and the second end 62 of the opening 55 equals the overturn.

The overturn means that the pivot plank 53 (including the supporting arm 50 and the displaying device 20) rotates relative to the support bar 41 (including the brace 40) at a vertical direction (perpendicular to the base 30). In this embodiment, relative rotation between the support bar 41 and the pivot plank 53 is substantially equal to 90 degrees when the support bar 41 rotates relative to the pivot plank 53 from the first end 61 to the second end 62 of the opening 55. A block plank 57 is disposed on the second end 62 of the opening 55. The support bar 41 is blocked by the block plank 57 when rotating at the second end 62, the support bar 41 stops rotation, and the displaying device 20 can be switched from the vertical mode (perpendicular to the base 30) to the parallel mode (parallel to the base 30). It is to say, the displaying device 20 can be overturned between the vertical mode and the parallel mode to adjust an angle along the perpendicular direction, and the rotation range is constrained within 90 degrees. Structure of the present invention can prevent the displaying device 20 from overturn, which results in entanglement and detachment of connecting wires (such as the power wire and the signal transmission wire, not shown in figures) of the displaying device 20. In the other embodiment, the rotation range can be enlarged or reduced (such as varying position of the block plank or taking away the block plank). The larger rotation range is suitable for the device with wireless transmission function, such as the tablet computer.

As connection between the sphere 42 and the arc surface 56, the pivot plank 53 can rotate to 360 degrees at a direction parallel to the radial direction of the support bar 41. The displaying device 20 can rotate to 360 degrees when the displaying device 20 is positioned at the parallel mode, the vertical mode, or any angle between the parallel mode and the vertical mode, so that the present invention has preferred convenience. For example, when two persons sit opposite to each other, the displaying device 20 can rotate parallel easily via the holder assembly 10 to show the displaying device 20 from one person to the other one. Further, the displaying device 20 can rotate from the vertical mode to the parallel mode rapidly via the holder assembly 10 to simultaneously show the displaying device 20 to the two persons for mutual discussion.

In conclusion, the holder assembly of the present invention can adjust the view angle of the displaying device conveniently and rapidly. The displaying device not only can execute parallel rotation relative to the holder assembly within 360 degrees, but also can overturn to 90 degrees at the perpendicular direction via the holder assembly. Comparing to the prior art, the present invention can increase rotation convenience of the displaying device and enhance utility of the displaying device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A holder assembly for supporting a displaying device, the holder assembly comprising:
a base;
a brace, an end of the brace being connected to the base, a sphere being disposed on the other end of the brace; and
a supporting arm, an end of the supporting arm being connected to the displaying device, a pivot portion being disposed on the other end of the supporting arm, the pivot portion corresponding to the sphere, and the sphere being rotatably disposed on the pivot portion.

2. The holder assembly of claim 1, wherein the pivot portion comprises two pivot planks, an arc surface is hollowly formed on each pivot plank, the two arc surfaces face to each other and fit in with a surface of sphere, the sphere is rotatably clamped between the two arc surfaces.

3. The holder assembly of claim 2, wherein the supporting arm comprises two lateral planks, ends of the two lateral planks are connected to the displaying device, the pivot planks are respectively disposed on the other ends of the two lateral planks.

4. The holder assembly of claim 3, wherein the two lateral planks are connected to each other, and an opening is formed between the two pivot planks.

5. The holder assembly of claim 4, wherein the brace comprises a support bar, a width of the opening is substantially equal to a sectional diameter of the support bar, the width of the opening is substantially smaller than a diameter of the sphere, an end of the support bar is connected to the sphere, and the other end of the support bar passes through the opening to connect the brace.

6. The holder assembly of claim 5, wherein the support bar rotates relative to the pivot plank between a first end and a second end of the opening.

7. The holder assembly of claim 6, wherein rotation between the support bar and the pivot plank is substantially equal to 90 degrees when the support bar rotates relative to the pivot plank from the first end of the opening to the second end of the opening.

8. The holder assembly of claim 7, wherein the arc surface comprises an abrasion proof layer, the abrasion proof layer contacts the sphere.

9. The holder assembly of claim 8, wherein the pivot plank and the sphere are made of aluminum alloy, zinc alloy, polyacetal or bakelite, the abrasion proof layer is made of polyacetal.

10. The holder assembly of claim 9, wherein a connect plank is pivotally disposed on an end of the lateral plank opposite to the pivot plank, the connect plank is connected to a connector conforming to VESA standard of the displaying device.
